(19) United States
(12) Patent Application Publication
(10) Pub. No.: US 2010/0007095 A1
(43) Pub. Date: Jan. 14, 2010

(54) CYLINDER HEAD GASKET WITH DUCT

(76) Inventor: Manfred Klinner, Troisdorf (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/280,443

(22) PCT Filed: Jan. 18, 2007
(86) PCT No.: PCT/EP2007/000438

§ 371 Date: Feb. 23, 2009

(30) Foreign Application Priority Data
Feb. 22, 2006 (DE) 10 2006 008 270.2

(51) Int. Cl. F02F 11/00

(52) U.S. Cl. 277/592

(57) ABSTRACT

A metal-elastomer cylinder head gasket has, in addition to one or more sealing layers made of metal, at least one combustion chamber seal and an elastomer seal which runs around the combustion chamber seal. Through ducts which are arranged in the plane of the cylinder head gasket, I addition, for example in the case of the engine block being filled with cooling fluid, a degassing is made possible, so that a discharging of air and/or gas remaining in the system is made possible into a fluid passage by means of the ducts.

The present invention relates to a metal/elastomer seal, and in particular a cylinder head gasket, which is suitable for use in internal combustion engines. The cylinder head gasket has, in addition to one or more sealing layers made of metal, at least one combustion chamber seal, and also an elastomer seal which runs around the combustion chamber seal. Cooling fluid is directed through at least one opening or bore arranged in the plane of the cylinder head gasket, in order to carry off the heat occurring between the motor block and the cylinder head. For example, in the case of charging the engine block with cooling fluid, a degassing is to be made possible, so that air and/or gas which remains in the system can be discharged in a fluid passage between the engine block, cylinder head flat seal, cylinder head.

To increase and ensure the sealing effect of a metallic seal over a lengthy period of time, it is usual to form a sealing function around the various passage openings in at least one of the layers of such a flat seal, which sealing function generally completely surrounds these passage openings. Through the sealing function, usually a corrugation or an elastomer profile, a corresponding sealing line is then produced. Here, depending on the requirement, usually one or more corrugations are used for sealing high pressure areas, for example of a combustion chamber, and elastomer profiles are used for sealing low pressure areas, for example of cooling fluid passages or to protect the engine block against environmental influences due to weather.

Such metallic seals with a corrugation or elastomer profile are usually used for sealing combustion chambers of a corresponding engine and in particular as cylinder head gaskets. Metal seals which frequently consist of several layers and are preferably made of steel have proved to be successful as cylinder head gaskets, in which the necessary elasticity is produced in that at least one of the layers has a corrugation surrounding the combustion chamber passage opening. In newer internal combustion engines, the cylinder head gaskets are increasingly manufactured predominantly from aluminium and the cylinder block predominantly from magnesium.

As during the operation of an internal combustion engine the breadth or width of the sealing gap, receiving the cylinder head gasket, between engine block and cylinder head alters periodically as a function of the working stroke of the respectively concerned cylinder, the cylinder head gasket is subject to constant changes in pressure in the operation of the engine. In the cylinder head gaskets of the type already mentioned, the sealing around a combustion chamber opening takes place at least substantially by a sealing corrugation surrounding the combustion chamber opening, which must have permanently spring-elastic characteristics to maintain a problem-free sealing owing to the changes in the sealing gap described above, i.e. the sealing corrugation must also still be deformable in a spring-elastic manner in the direction perpendicular to the sealing plate plane after a long period of engine operation. The same applies to a lesser extent for the elastomer profiles which are used to seal the low pressure area.

Frequently in present-day internal combustion engines, cylinder head gaskets are used in which respectively for permanently elastic combustion chamber sealing, so-called full corrugations are used, impressed into spring steel. Full corrugations are distinguished in that, starting from a base surface of the sheet metal, an elevation is formed in one direction, so that a contact line (corrugation crest) is formed to the side facing away from the base surface, as a sealing line. Full corrugations rest in the plane of the base surface always with so-called corrugation feet arranged on both sides of the corrugation crest, i.e. two sealing lines form in the plane of the base surface. This basic construction of a full corrugation requires a minimum amount of space in cross-section and must be formed by relatively complex stamping tools.

In U.S. Pat. No. 6,530,575 a seal is described which contains a metal core consisting of a soft steel, which is provided completely with an elastomer layer in the region of the two sealing surfaces. For better clamping of the elastomer material, the metal core has apertures and, if necessary, also curves. The elastomer material is applied cold on the associated surface and is hardened in a heated form before it is vulcanized. Profiles which have a triangular cross-section are introduced in the elastomer material.

DE4438879 relates to a single- or multi-layered metallic cylinder head gasket for internal combustion engines with a pre-combustion chamber, in which a component having the pre-combustion chamber is incorporated into the cylinder head and in the assembled state of the seal rests with a base surface on the seal, and also at least one corrugation running outside the base surface, surrounding the combustion chamber opening. In order to reduce the thermal stress in the region of the pre-combustion chamber, in addition an arched slit is arranged in front of the corrugation in the region of the outer edge of the component, so that the transportation of heat in this area from component to corrugation is eliminated.

In EP1083371 a cylinder head gasket is described in which a penetration of combustion gases into the cooling water circuit is avoided by a corresponding arrangement of the sealing means.

The cylinder head gaskets described in the above prior art all have the disadvantage that in an operation of the engine block with cooling fluid, corresponding air remains in the system and can not be carried off. Air can occur for example in the form of small air bubbles in a bore of the engine block and can accumulate on the metallic seal, which can lead to its corrosion. Likewise, during the operation of the engine, hot combustion gases can emerge from a combustion chamber seal which may be defective and can again lead to the corrosion of metallic materials.

An object of the present invention therefore consists in providing a possibility of carrying off air and/or gases which are present which can occur for example during the operation of the engine block and therefore of avoiding corrosion of metallic components.

A further object of the present invention consists in avoiding a penetration of gases, in particular of hot combustion gases, into undesired areas of the engine block.

The above problems were solved by the provision of the cylinder head gasket according to the invention. The cylinder head gasket comprises substantially one or more metallic sealing layers and one or more combustion chamber seals suitable for sealing the high pressure area. The expression “high pressure area” refers here to the area surrounded by a combustion chamber seal. In addition, preferably an elastomer seal suitable for sealing a low pressure area is arranged around the combustion chamber seal(s). During the operation of the engine with cooling fluid, it frequently occurs that gases and/or air remain in the engine block in the plane of the cylinder head gasket, or are partially or completely carried off through an opening formed in the plane of the seal. According to the present invention, the plane of the cylinder head gasket has a duct or a depression in at least one of the sealing layers, which duct or depression ensures a specific discharging of the gases and/or air through this opening.

It is thereby ensured that in the state of the installed cylinder head flat seal a fluid, brought up for example through the engine block lying therebeneath, i.e. gas or fluid, is transported through the duct to a cooling fluid opening of the cylinder head gasket, through which the fluid is transported off in a suitable manner.

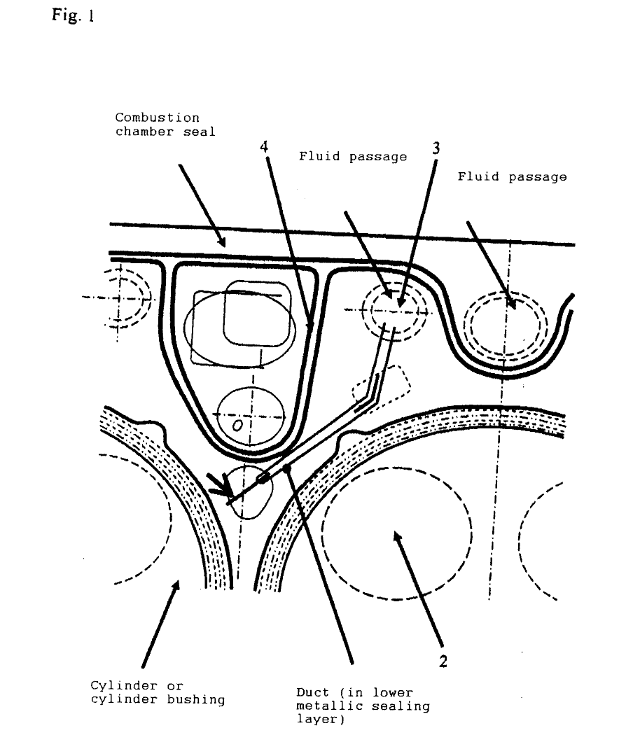

FIG. 1 shows a top view onto a cylinder head gasket according to the invention.

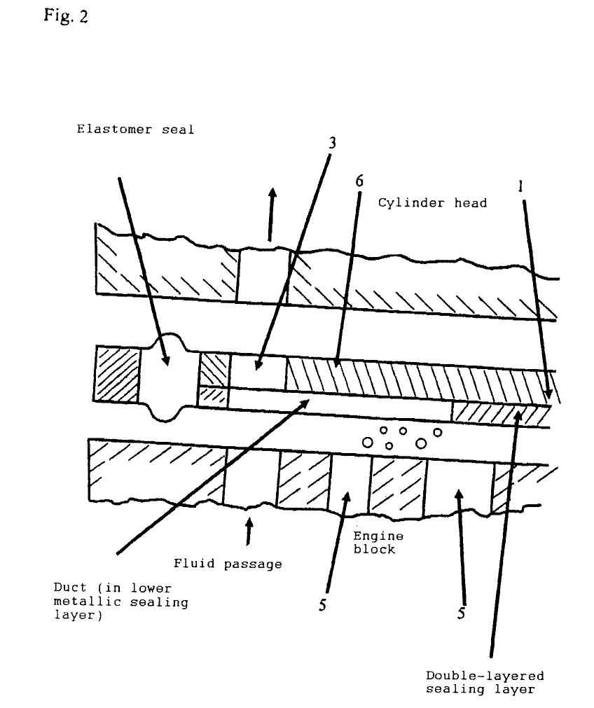

FIG. 2 shows on the right a sectional view of the cylinder head gasket according to the invention of FIG. 1.

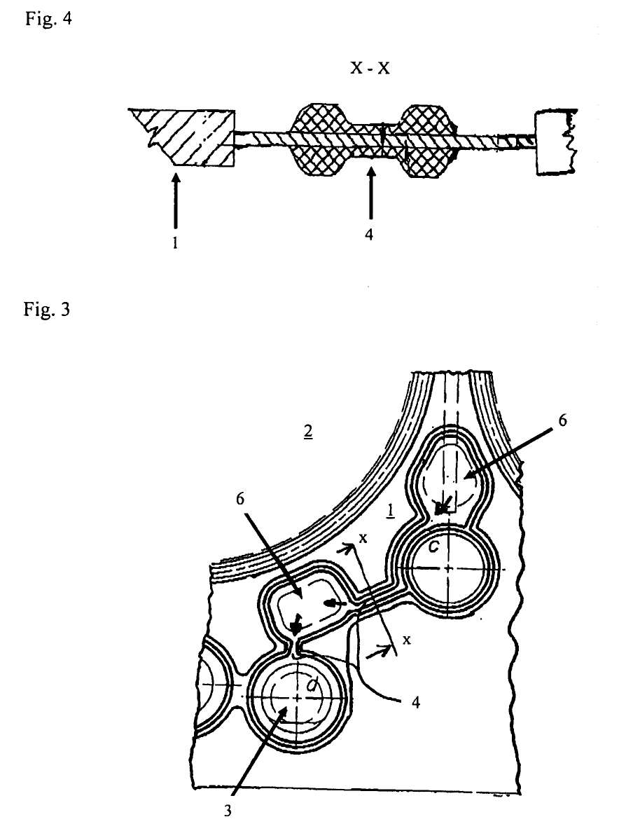

FIG. 3 shows a view of another cylinder head gasket according to the invention as a block view.

FIG. 4 shows a cross-section along the line x-x of FIG. 3

According to the invention, a cylinder head gasket is provided, which comprises at least one sealing layer 1 of metal, at least one combustion chamber seal, openings 2 around the combustion chambers and an elastomer seal running around the combustion chamber seal(s). The cylinder head seal is further characterized in that at least one duct 4 in the plane of the cylinder head gasket runs in at least one sealing layer and intersects a fluid opening 3.

The production of metallic seals is well known to the specialist in the art and can be carried out according to the respective specifications and requirements by means, for example, of a CNC machine. The metallic sealing layer can be produced for example by folding or pressing the respective metal for example from various steels or magnesium. The combustion chamber seal surrounds a high pressure area in a sealing manner, such as for example a cylinder or cylinder bushing, in order to avoid an emergence of the combustion gases. The sealing of the combustion chamber takes place for example by means of one or more corrugations in at least one of the metallic sealing layers. The formation of corrugations is known to the specialist in the art and comprises for example corresponding folding or pressing of the metal of the sealing layer(s).

In addition, an elastomer seal consisting for example of silicones, fluorosilicones, fluoroelastomers, fluorothermoplasts, polyether ether ketones (PEEK), polyphenylene sulphide (PSU), polyamidimiden (PAI) and inherently strengthened liquid crystalline polymers (LCP), runs around the combustion chamber seal. The elastomer is applied in the form of a coating on at least one sealing layer, in which the sealing layer is provided with one or more impression areas receiving the elastomer material. The production of the impression area can take place for example by folding or pressing the sealing layer material. To apply the elastomer material into the impression area, the so-called liquid elastomer moulding (LEM) method is used for example, which is described in U.S. Pat. No. 6,530,575. Other methods for the application of the elastomer coating are known from the prior art. Screen printing is suitable here, in which the material itself or else dispersions of the material are applied. Likewise, an injection moulding method is well suited to the application of the elastomer coating.

The coolant opening 3, in which the at least one duct 4 opens, constitutes a low pressure area here and makes it possible to discharge any possibly accumulated gases and/or air out from the engine block, without a distribution taking place. The opening 3 of the fluid passage can be partially provided (with the exception of the inflowing duct) with a suitable sealing means for sealing to one or more sides, such as for example an elastomer seal. Through the flowing fluid, in addition a suction effect occurs, which favours the transporting away of air and/or gases through the at least one duct. The air and/or gases can, in turn, dissolve in the fluid.

In the region or in the plane of the cylinder head gasket, gases and/or air can occur between the elastomer seal and the combustion chamber seal, which have a disadvantageous effect on the operation of the engine. For example, with the filling of the engine with coolant, air which is introduced at the same time can be present in the area, and during the subsequent operation of the engine can lead to deposits on the seals and to permeability of the elastomer seal or of the combustion chamber seal.

Through the at least one duct 4 formed in the area, a possibility is now provided in the present invention for carrying off these gases and/or air via the opening 3 of a fluid passage. It is, in addition, advantageous here that hot emerging combustion gases in the case of any permeability of the combustion chamber seal do not accumulate in the plane of the cylinder head gasket and damage the sealing material or metallic components, but rather are likewise carried off specifically into an area in which no disadvantageous effects can occur. Such a duct or ducts can be produced by means of methods known to the specialist in the art, including stamping, milling, impressing or a combination of these methods, in the plane of the cylinder head gasket in at least one sealing layer. It should be clear in addition that the at least one duct 4 is formed in the plane of the cylinder head gasket such that no impairment occurs to the sealing function of the combustion chamber seal, i.e. that the duct is formed at a sufficient distance from the seal, in order to ensure a problem-free functioning thereof.

According to a preferred embodiment of the present invention, one end of the at least one duct intersects a fluid hole 5 of the engine block lying therebeneath and therefore produces a connection between for example two fluid openings, whereby likewise an improved degassing is made possible. The fluid hole 5 can likewise for example be a coolant passage here or a passage which ends in the sealing layer.

According to a further preferred embodiment, the opening 3 is a coolant passage. Examples of corresponding coolant are water and/or oil, for which bores are already present in the engine block and in the cylinder head. An already present water passage is preferred as an end point of the at least one duct.

According to another embodiment, the at least one duct 4 is stamped, milled and/or impressed into the sealing layer of metal. Corresponding methods for this are known to the specialist in the art and can also be combined if required.

In the embodiment shown in FIGS. 3 and 4, an elastomer material is applied on both sides on the sealing layer 1 of metal, which elastomer material forms the duct 4 through a depression or groove provided in the elastomer material. Thereby, the fluid can flow along the arrows illustrated in FIG. 3, and namely for example from the fluid hole 5 to the fluid opening 3. The seal acts accordingly in the region of the openings or holes like a shutter 6, which together with the duct 4 forms a flow path for the fluid which is to be directed. In order to be able to receive the elastomer material, the sealing layer 1 is preferably thinned or deepened, as can be seen in FIG. 4.

According to a further preferred embodiment of the present invention, the at least one sealing layer of metal has a layer thickness of 0.2 to 4.0 mm, preferably 0.8 to 2.2 mm and above, preferably 1.2 to 2.0 mm.

According to another further preferred embodiment, the at least one duct or the depression in the metal of the sealing layer has a depth of 0.05 to 0.5 mm and a width of 0.01 to 0.5 mm. Preferred dimensions of the at least one duct are a depth of 0.08 to 0.2 mm and a width of 0.01 to 0.2 mm. Even more preferred are a depth of 0.1 to 0.15 mm and a width of 0.1 to 0.15 mm. It should be clear here that the duct depth is selected as a function of the layer thickness of the sealing layer so that the selected duct depth is always smaller than the layer thickness of the sealing layer.

According to a preferred embodiment, at least two sealing layers are present, which consist of various metals. The metal may, for example, be a steel, such as spring steel or fine steel, or magnesium or aluminium. For reasons of different thermal expansion coefficients of the selected metal, it can be favourable to select combined layers of various metals which are known to the specialist in the art.

According to a further embodiment, the metal is a steel, such as for example spring steel or a fine steel, such as V4 steel.

According to a still further embodiment of the present invention, the at least one combustion chamber seal is formed from one or more corrugations. The seal around a combustion chamber opening takes place here substantially through the sealing corrugation surrounding the combustion chamber opening, which corrugation, to maintain a problem-free sealing, is to have permanently spring-elastic characteristics owing to the sealing gap changes described above, i.e. the sealing corrugation must also still be deformable in a spring-elastic manner in the direction perpendicular to the sealing plate plane after lengthy operation of the engine.

According to a further embodiment, the material of the elastomer seal consists of silicones, fluorosilicones, fluoroelastomers, fluorothermoplasts, polyether ketones (PEEK), polyphenylene sulphide (PSU), polyamideimide (PAI) and inherently strengthened liquid crystalline polymers (LCP). Preferred materials here are fluorosilicones, fluoroelastomers or fluorothermoplasts.

According to a further embodiment, the cylinder head gasket has deformation limiters, which are arranged around the corresponding seals, elastomer seal and/or combustion chamber seal.

The deformation limiter limits the possible deformation of the respective seal, for example of a sealing corrugation. This means that the elastic path of the corrugation is limited, whereby the sealing corrugation is protected from an inadmissibly high deformation. Such a deformation limiter is also designated as a stop. Such a stop frequently has the form of a metallic circular ring which has been applied radially outside or radially inside the sealing corrugation onto the metal layer in which the sealing corrugation is formed; in the case of a multi-layered sealing plate, the stop can also be applied onto a sheet metal layer adjacent to the said metal layer, so that it lies against the sheet metal layer provided with the sealing corrugation when the cylinder head gasket is fixed, and namely lies radially inside or radially outside this corrugation. Further examples of such stops are known from the prior art, such as from U.S. Pat. No. 5,713,580. The form and production of suitable deformation limiters are well known to the specialist in the art.

It should be clear that the cylinder head gasket according to the invention can be used not only in the manufacture of engines for automobiles, but also of other internal combustion engines. The manufacture of the cylinder head gasket according to the invention can, moreover, take place with the same tools as for cylinder head gaskets according to the prior art, because only one station variant is necessary in the tool for the formation of the duct.

1. A cylinder head gasket, comprising:
at least one sealing layer of metal, with openings for the combustion chambers;
at least one combustion chamber seal around the openings; and at least one opening formed in the metal sealing layer for the passage of cooling fluid;
wherein in the plane of the cylinder head gasket at least one duct is formed in at least one sealing layer, which duct or depression intersects the opening for the cooling fluid.

2. The cylinder head gasket according to claim 1, in which the at least one duct intersects an opening of a fluid hole in the engine block, so that the seal functions as a shutter in the region of the engine block.

3. The cylinder head gasket according to claim 1, in which the opening is a coolant passage.

4. The cylinder head gasket according to claim 1, in which the at least one duct is stamped, milled and/or impressed into the sealing layer of metal.

5. The cylinder head gasket according to claim 1, wherein the duct is formed from elastomer material.

6. The cylinder head gasket according to claim 1, in which the at least one sealing layer of metal has a material thickness of 0.2 to 4.0 mm.

7. The cylinder head gasket according to claim 7, in which the at least one duct has a depth of 0.05 to 0.5 mm and a width of 0.01 to 0.5.

8. The cylinder head gasket according to claim 1, including at least two sealing layers which consist of different metals.

9. The cylinder head gasket according to claim 1, in which the metal of the sealing layer is made of steel.
